(19) United States
(12) Patent Application Publication
(10) Pub. No.: US 2026/0030928 A1
(43) Pub. Date: Jan. 29, 2026

(54) APPARATUS AND METHOD FOR BEHAVIOR RECOGNITION BASED ON NOISE SKELETON SEQUENCE

(71) Applicant: SK TELECOM CO., LTD., Seoul (KR)

(72) Inventors: Chun Fei MA, Seoul (KR); Young Chul YOON, Seoul (KR); Byeong Won LEE, Seoul (KR); Jin Seong JANG, Seoul (KR)

(21) Appl. No.: 19/347,824

(22) Filed: Oct. 2, 2025

Related U.S. Application Data
(63) Continuation of application No. PCT/KR2024/007350, filed on May 29, 2024.

(30) Foreign Application Priority Data
Jun. 9, 2023 (KR) 10-2023-0073992

(51) Int. Cl. G06V 40/20; G06T 7/246

(52) U.S. Cl. CPC G06V 40/20; G06T 7/246; G06T 2207/20044

(57) ABSTRACT

In a method and apparatus for behavior recognition based on noise skeleton sequence, the method includes preparing a first skeleton sequence extracted by a skeleton extraction model from a first training image sequence and a behavior label of the first skeleton sequence, wherein the first skeleton sequence includes first noise caused by the skeleton extraction model; and training a behavior recognition model based on the first skeleton sequence and the behavior label of the first skeleton sequence.

### CROSS-REFERENCE TO RELATED APPLICATION

The present application is a continuation of International Application No. PCT/KR2024/007350, filed May 29, 2024, which is based upon and claims priority to Korean Patent Application No. 10-2023-0073992, filed on Jun. 9, 2023 in Korea. The entire disclosure of the above application is incorporated herein by reference.

### TECHNICAL FIELD

The present disclosure relates to an apparatus and a method for behavior recognition based on a noise skeleton sequence.

### BACKGROUND

The statements in this section merely provide background information related to the present disclosure and do not necessarily constitute prior art.

With recent advances in IT technologies, research on recognizing behaviors of objects from camera images is being actively pursued. Behavior recognition technology is used in various fields, including analysis of human behavior patterns, abnormal-behavior detection, and intruder detection.

Among various behavior recognition techniques, one approach involves recognizing an object's behavior based on its skeleton representation. A skeleton-based behavior recognition technique analyzes changes in human posture based on human skeletons in a predetermined image sequence and recognizes types of human behavior from the posture changes.

In particular, a skeleton-based behavior recognition technique may recognize human actions using a deep-learning-based behavior recognition model. Here, the behavior recognition model is a model trained to output the type of human behavior from human skeleton data. At this time, skeleton data manually annotated by an operator is used as labels for the training data of the behavior recognition model. The annotated skeleton data may be referred to as ground truth (GT).

A behavior recognition model exhibits high recognition performance for input data whose distribution is similar to that of the training data. In contrast, when skeleton data in the inference stage has a distribution different from that of the training data, the behavior recognition performance of the behavior recognition model may degrade.

Specifically, although accurate skeleton data manually annotated is used for training of the behavior recognition model, inaccurate skeleton data extracted from images by a skeleton extraction model is used for inference of the behavior recognition model. In other words, the environment settings for training and those for inference of the behavior recognition model are different. A behavior recognition model trained with manually annotated skeleton data may incorrectly classify behavior types for skeleton data extracted by the skeleton extraction model.

In particular, a skeleton extraction model may incorrectly extract joints that exhibit large motion among human joints. For a given behavior type, joints with large motion variation may fail to be detected or may be detected at incorrect positions. For example, in running behavior, the legs and arms exhibit large motion variation. Skeleton data for the leg region extracted by the skeleton extraction model from images of running behavior may include large errors. Accordingly, the behavior recognition model may misclassify the behavior type for the extraction results of the skeleton extraction model.

To address the problem, the behavior recognition model needs to be trained with skeleton data representing a variety of postures. This requires the operator to annotate a lot more data, which incurs significant cost and time.

Therefore, research is needed to improve the performance of the behavior recognition model in addition to alleviating the annotation burden on the operator.

### SUMMARY

The embodiments of the present disclosure are primarily directed to providing a training method and apparatus for preventing degradation of a behavior recognition model's performance on skeleton data whose distribution differs from that of the training data, even when only a small number of ground-truths are available.

Technical objects to be achieved by the present disclosure are not limited to those described above, and other technical objects not mentioned above may also be clearly understood from the descriptions given below by those skilled in the art to which the present disclosure belongs.

According to various aspects of the present disclosure, the present disclosure provides a method includes preparing a first skeleton sequence extracted by a skeleton extraction model from a first training image sequence and a behavior label of the first skeleton sequence, wherein the first skeleton sequence includes first noise caused by the skeleton extraction model; and training a behavior recognition model based on the first skeleton sequence and the behavior label of the first skeleton sequence.

According to various aspects of the present disclosure, the present disclosure provides an apparatus including a memory storing instructions; and at least one processor, wherein the at least one processor executing the instructions performs steps comprising: preparing a first skeleton sequence extracted by a skeleton extraction model from a first training image sequence and a behavior label of the first skeleton sequence, wherein the first skeleton sequence includes first noise caused by the skeleton extraction model; and training a behavior recognition model based on the first skeleton sequence and the behavior label of the first skeleton sequence.

According to various aspects of the present disclosure, the present disclosure provides a method includes obtaining an input skeleton sequence extracted from an input image sequence; and determining a behavior type for the input skeleton sequence using a behavior recognition model, wherein the behavior recognition model is trained by: preparing a first skeleton sequence extracted by a skeleton extraction model from a first training image sequence and a behavior label of the first skeleton sequence, wherein the first skeleton sequence includes first noise caused by the skeleton extraction model; and training the behavior recognition model based on the first skeleton sequence and the behavior label of the first skeleton sequence.

As described above, according to one embodiment of the present disclosure, degradation in the performance of a behavior recognition model may be prevented on skeleton data having a distribution different from that of training data even with a small number of ground truth data.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 illustrates the structure of a behavior recognition system according to one embodiment of the present disclosure.

FIG. 2 illustrates training of a behavior recognition model according to one embodiment of the present disclosure.

FIG. 3 illustrates training of a behavior recognition model according to another embodiment of the present disclosure. FIG. 4 illustrates training of a behavior recognition model according to yet another embodiment of the present disclosure.

FIG. 5 illustrates first skeleton data and second skeleton data according to one embodiment of the present disclosure.

FIG. 6 is a flowchart of a training method for a behavior recognition model according to one embodiment of the present disclosure.

FIG. 7 is a flowchart of a behavior recognition method according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

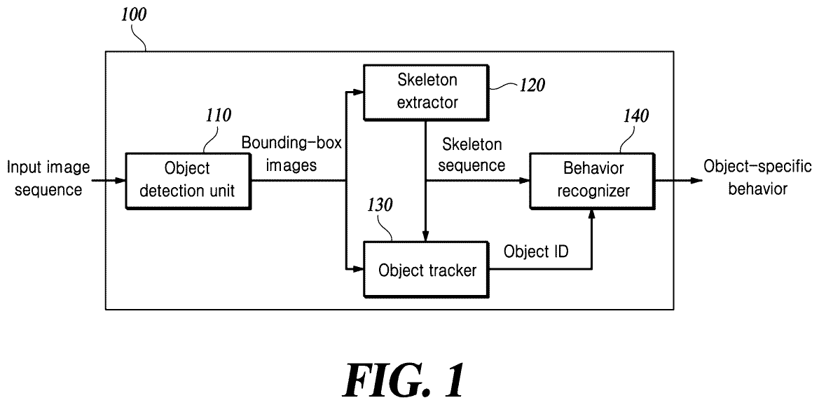

FIG. 1 illustrates the structure of a behavior recognition system according to one embodiment of the present disclosure.

Referring to FIG. 1, the behavior recognition system 100 is a system that recognizes behavior of objects within images. For example, the behavior recognition system 100 may identify and track people in an input image sequence and may recognize human behaviors such as sitting, standing, running, or falling. In another example, the behavior recognition system 100 may also recognize behaviors of animals other than humans.

To this end, the behavior recognition system 100 may include an object detection unit 110, a skeleton extractor 120, an object tracker 130, and a behavior recognizer 140. The behavior recognition system 100 may include at least one processor and a memory storing at least one instruction and may perform the functions of the object detection unit 110, the skeleton extractor 120, the object tracker 130, and the behavior recognizer 140 through execution of the instructions by the at least one processor. In another embodiment, the object detection unit 110, the skeleton extractor 120, the object tracker 130, and the behavior recognizer 140 may be implemented as separate devices.

The object detection unit 110 detects objects in an image. Here, an object may refer to a graphical object representing a person.

Specifically, the object detection unit 110 may detect bounding boxes that include objects in each image of an input image sequence using an object detection model. Here, one bounding box may include at least one object.

Meanwhile, the object detection model is a deep-learning model pre-trained to generate bounding boxes of objects and may have a convolutional neural network architecture. For example, when multiple persons are present in images, the object detection unit 110 may detect a bounding box for each person. Thereafter, the object detection unit 110 may extract bounding-box images corresponding to the regions of the bounding boxes from the images.

The skeleton extractor 120 extracts skeleton data of an object in the bounding-box images using a skeleton extraction model. The skeleton extractor 120 extracts skeleton data from each bounding-box image and outputs a skeleton sequence that represents sequential skeleton data.

Here, skeleton data of an object includes human joints and links between the joints. For example, the skeleton data may include the position coordinates of a person's head, shoulders, elbows, wrists, pelvis, knees, and ankles and their connection relationships. Furthermore, the skeleton data may further include joint parts such as eyes, nose, mouth, ears, neck, fingertips, torso, and toes.

A skeleton sequence is a set of skeleton data sequentially extracted from the bounding-box images. A skeleton sequence may be composed of N frames, and each frame may include K joint points and connection relationships between the joint points. For example, a skeleton sequence may include ten joint points and connection relationships between the joint points extracted from each of the ten bounding-box images.

The skeleton extraction model is a deep-learning model pre-trained to extract skeleton data of an object from a given image and may have a convolutional neural network architecture. In one example, the skeleton extraction model may sequentially extract skeleton data for given images. In another example, the skeleton extraction model may extract skeleton data in parallel.

The skeleton extraction model may be adapted or fine-tuned based on the input image sequence.

The object tracker 130 tracks an object based on the bounding-box images and the skeleton sequence and assigns an ID to the object.

The object tracker 130 may identify bounding-box images corresponding to the same object using a tracking algorithm. Here, since tracking algorithms are well known in the technical field of object tracking, a detailed description thereof will be omitted.

The behavior recognizer 140 may determine the behavior type for a skeleton sequence using the behavior recognition model and, based on the object ID and the behavior type, may determine the object-specific behavior type.

Here, the behavior type may include human behaviors such as sitting, standing, running, or falling.

The behavior recognizer 140 may input the skeleton sequence into the behavior recognition model, obtain a probability distribution for behavior types output from the behavior recognition model and determine the behavior type for the skeleton sequence based on the probability distribution for the behavior types. For example, the behavior recognizer 140 may determine the behavior type having the highest probability.

The behavior recognition model is a deep-learning model and may have various architectures such as the Graph Convolutional Network (GCN), Spatial-Temporal GCN (ST-GCN), Actional Structural GCN (AS-GCN), and Convolutional Neural Network-Long Short-Term Memory (CNN-LSTM).

The behavior recognition model is trained to receive a skeleton sequence as input and to output a probability distribution for multiple behavior types. The behavior recognition model may be trained so that a difference between a behavior label corresponding to the skeleton sequence and the probability distribution output from the behavior recognition model is reduced. Here, one behavior type indicates one class, and the probability distribution over the behavior types may indicate confidence scores.

In particular, to prevent degradation of behavior recognition performance due to differences between training data and inference data, the behavior recognition model is trained based on skeleton sequences that include noise. The skeleton sequences including noise are similar to input skeleton sequences that represent inference data of the behavior recognition model.

Specifically, the noise includes at least one of first noise caused by the skeleton extraction model and second noise generated based on motion statistics of joints for the behavior types.

The behavior recognition model is trained based on at least one of a first skeleton sequence including the first noise and a second skeleton sequence including the second noise.

Behavior labels of the first skeleton sequence and the second skeleton sequence may be generated by an operator. Furthermore, the behavior recognition model may be further trained with a skeleton sequence corresponding to ground truth that is manually annotated.

Meanwhile, the behavior recognition model may process skeleton sequences of multiple persons sequentially or in parallel. The behavior recognition model may be trained by the behavior recognition system 100 or may be trained by a training apparatus different from the behavior recognition system 100.

As described above, because the behavior recognition model is trained with skeleton sequences having a distribution similar to that of input skeleton sequences of an inference target, behavior recognition performance affected by differences between training data and inference data may be improved.

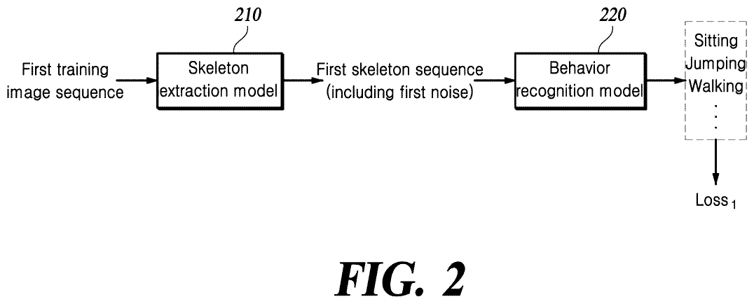

FIG. 2 illustrates training of a behavior recognition model according to one embodiment of the present disclosure.

Referring to FIG. 2, the behavior recognition model 220 is trained based on a first skeleton sequence extracted by the skeleton extraction model 210.

The behavior recognition model 220 may be trained by a training apparatus that includes at least one processor and at least one memory. By executing instructions stored in the at least one memory, the at least one processor may perform a training method of the behavior recognition model 220.

First, the training apparatus prepares a first image sequence. The first image sequence includes a series of bounding-box images for one person.

The training apparatus extracts a first skeleton sequence from a first training image sequence using the skeleton extraction model 210. The skeleton extraction model 210 extracts positions and connection relationships of human joints in the first training image sequence. The skeleton extraction model 210 may process images in the first training image sequence sequentially or in parallel.

At this time, the first skeleton sequence extracted by the skeleton extraction model 210 may include first noise caused by the skeleton extraction model 210. The first skeleton sequence is inaccurate skeleton data that includes errors caused by the skeleton extraction model 210. However, compared with ground truth, the first skeleton sequence may be similar to an input skeleton sequence extracted by the skeleton extraction model 210 from an input image sequence at the inference stage of the behavior recognition model 220.

To induce first noise having appropriate magnitude, the skeleton extraction model 210 may be constructed with a predetermined number of parameters or more. If the capacity, which represents the number of parameters of the skeleton extraction model 210, is too small, the first noise may increase; accordingly, the skeleton extraction model 210 may have to be built with an appropriate capacity.

Furthermore, the training apparatus prepares a behavior label for the first skeleton sequence. The behavior label of the first skeleton sequence indicates a behavior type represented by the first skeleton sequence. For example, the behavior label of the first skeleton sequence may be a one-hot encoded vector.

The training apparatus inputs the first skeleton sequence to the behavior recognition model 220 and obtains a probability distribution over behavior types for the first skeleton sequence. For example, the behavior recognition model 220 receives the first skeleton sequence as input and outputs a probability distribution over behavior types such as sitting, jumping, and walking.

The training apparatus compares the probability distribution output by the behavior recognition model 220 with the behavior label of the first skeleton sequence and updates parameters of the behavior recognition model 220 based on the comparison result. Specifically, the training apparatus computes a first loss Loss 1 according to the probability distribution output by the behavior recognition model 220 and the behavior label of the first skeleton sequence and may update the behavior recognition model 220 so that the first loss is reduced.

Here, to compute the first loss, classification loss functions such as cross-entropy, multi-class log loss, binary cross-entropy, or categorical cross-entropy may be used. In other words, the training apparatus may compute the first loss by applying a classification loss function to the probability distribution output by the behavior recognition model 220 and to the behavior label of the first skeleton sequence.

As described above, when the behavior recognition model 220 is trained using the first skeleton sequence extracted from the first training image sequence by the skeleton extraction model 210 and, at the inference stage, infers a behavior from an input skeleton sequence extracted from an input image sequence by the skeleton extraction model 210, the difference between training data and inference data is reduced, and thus behavior recognition performance of the behavior recognition model 220 may be improved.

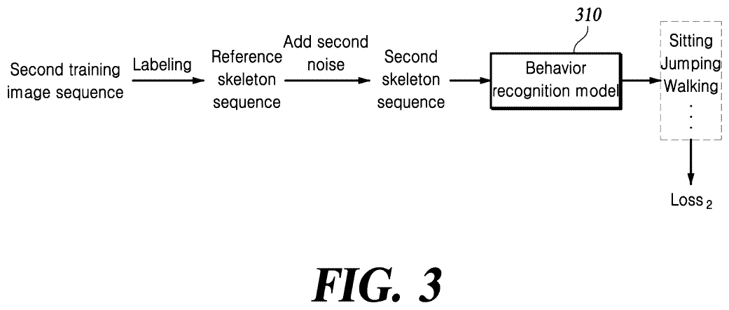

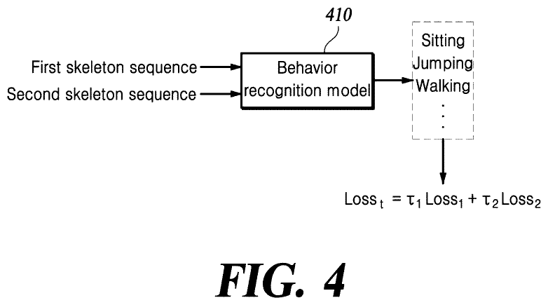

FIG. 3 illustrates training of a behavior recognition model according to another embodiment of the present disclosure.

Referring to FIG. 3, the behavior recognition model 310 is trained based on a second skeleton sequence corresponding to second noise generated from motion statistics of joints for the behavior types.

Here, the second noise is noise generated based on the motion statistics of joints for the behavior types. The second noise is introduced to make a reference skeleton sequence corresponding to ground truth similar to inference data of the behavior recognition model 310.

Specifically, for a particular behavior type, the amount of motion differs for each joint. For example, in the human running behavior, the arms and legs move more than the torso. Also, in the jumping and sitting behaviors, the legs exhibit a substantial amount of motion.

A skeleton extraction model used for inference of the behavior recognition model 310 may exhibit degraded detection performance for joints with large motion. For example, leg joint positions extracted to infer the human running behavior by the skeleton extraction model may differ from actual leg joint positions and may have larger errors than joints in other body parts.

When the behavior recognition model 310 is trained with a reference skeleton sequence corresponding to ground truth, the behavior recognition model 310 may have a high likelihood of misclassifying a behavior type for a skeleton sequence that includes errors varying by human body part.

Accordingly, the training apparatus trains the behavior recognition model 310 based on a second skeleton sequence modified according to motion statistics of joints for behavior types.

First, the training apparatus prepares a second image sequence. The second image sequence may be the same as or different from the first image sequence of FIG. 2.

Thereafter, a reference skeleton sequence for the second image sequence is generated by labeling. The reference skeleton sequence includes human joint points and links connecting the joint points in the second image sequence. The reference skeleton sequence is ground truth that is manually generated by an operator. Otherwise, the reference skeleton sequence may be generated by a labeling model. The reference skeleton sequence accurately represents human joint points and links connecting the joint points.

The training apparatus store, in advance, motion statistics of joints for the behavior types. The motion statistics of joints for the behavior types include, for each behavior type, the amount of motion change for each joint.

The training apparatus may generate second noise based on the motion statistics of joints for the behavior types. For example, the training apparatus may set a range according to the degree of motion of a particular joint and may randomly generate, within the set range, a displacement and a movement direction of the corresponding joint as the second noise.

The training apparatus may generate a second skeleton sequence by adding the second noise to the reference skeleton sequence. The training apparatus may generate the second skeleton sequence by moving the respective joint positions in the reference skeleton sequence according to the second noise.

Thereafter, the training apparatus inputs the second skeleton sequence to the behavior recognition model 310 and obtains a probability distribution over behavior types for the second skeleton sequence. The training apparatus compares the probability distribution output by the behavior recognition model 310 with a behavior label of the second skeleton sequence and updates parameters of the behavior recognition model 310 based on the comparison result. The training apparatus computes a second loss Loss2 according to the probability distribution output by the behavior recognition model 310 and the behavior label of the second skeleton sequence and may update the behavior recognition model 310 so that the second loss is reduced. The loss function for computing the second loss may be one of the classification loss functions described above.

As described above, when the behavior recognition model 310 is trained on the second skeleton sequence generated based on motion statistics of joints for the behavior types, difference between training data and inference data may be reduced, thereby improving behavior recognition performance of the behavior recognition model 310.

Furthermore, because the second skeleton sequence is augmented from the reference skeleton sequence, a cost for building training data of the behavior recognition model 310 may be reduced.

FIG. 4 illustrates training of a behavior recognition model according to yet another embodiment of the present disclosure.

Referring to FIG. 4, the behavior recognition model 410 may be trained with both a first skeleton sequence extracted by a skeleton extraction model and a second skeleton sequence including the second noise generated based on motion statistics of joints for the behavior types.

Here, the first skeleton sequence and the second skeleton sequence are as described in FIGS. 2 and 3, respectively.

The training apparatus may compute a first loss based on the first skeleton sequence and a behavior label of the first skeleton sequence, compute a second loss based on the second skeleton sequence and a behavior label of the second skeleton sequence, and compute the overall loss of the behavior recognition model 410 as a weighted sum of the first loss and the second loss. Weights T₁ and T₂, which represent the weighting ratio between the first and second losses, may be set heuristically.

The training apparatus may update parameters of the behavior recognition model 410 so that the overall loss decreases.

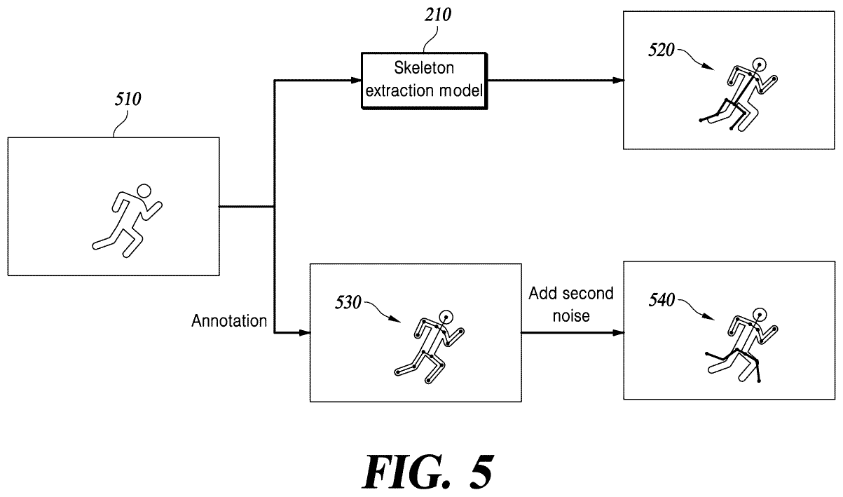

FIG. 5 illustrates first skeleton data and second skeleton data according to one embodiment of the present disclosure.

Referring to FIG. 5, a training image 510 capturing the human walking motion is shown.

At the inference stage of the behavior recognition model, an input skeleton sequence extracted from an input image sequence by the skeleton extraction model 210 includes noise. In particular, joints exhibiting large motion are likely to contain relatively large errors. To improve inference performance of the behavior recognition model, skeleton sequences including such noise are used as training data.

First, the training apparatus may input the training image 510 to the skeleton extraction model 210 to extract first skeleton data 520. Here, the first skeleton data 520 includes first noise caused by the skeleton extraction model 210. In the first skeleton data 520, lower-body joints are displaced according to the first noise.

The training apparatus may obtain reference skeleton data 530 that is manually annotated for the training image 510 and may generate second skeleton data 540 by adding second noise to the reference skeleton data 530. Statistically, since walking behavior exhibits substantial motion of legs, larger noise is added to lower-body joints than to upper-body joints in the reference skeleton data 530. Accordingly, in the second skeleton data 540, the lower-body joints are more widely spread.

In the inference stage of the behavior recognition model, because the skeleton sequence input to the behavior recognition model is extracted by the skeleton extraction model 210, it is highly likely to include errors similar to those in the first skeleton data 520 and the second skeleton data 540.

The behavior recognition model trained with the reference skeleton data 530 exhibits low recognition performance for the skeleton data similar to the first skeleton data 520 and the second skeleton data 540, whereas the behavior recognition model trained with the first skeleton data 520 and the second skeleton data 540 exhibits high recognition performance for the skeleton data similar to the first skeleton data 520 and the second skeleton data 540.

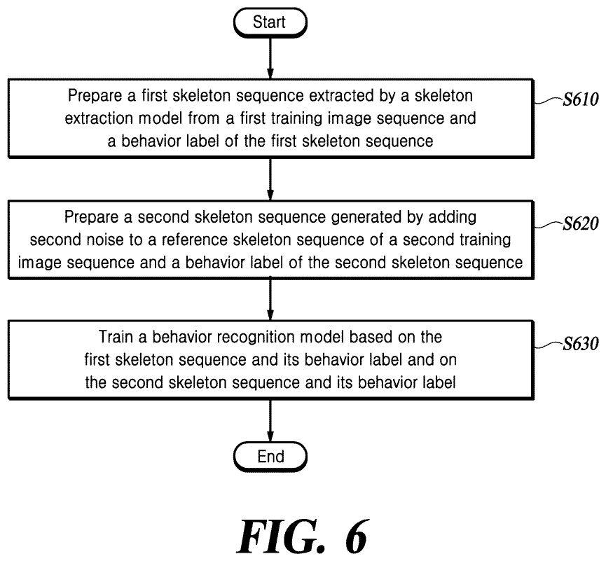

FIG. 6 is a flowchart of a training method for a behavior recognition model according to one embodiment of the present disclosure.

Referring to FIG. 6, a training apparatus for training a behavior recognition model prepares a first skeleton sequence extracted by a skeleton extraction model from a first training image sequence and a behavior label of the first skeleton sequence S610.

Here, the first skeleton sequence includes first noise caused by the skeleton extraction model.

Also, the training apparatus prepares a second skeleton sequence generated by adding second noise to a reference skeleton sequence of a second training image sequence and a behavior label of the second skeleton sequence S620.

Here, the second noise is generated based on motion statistics of joints for the behavior types.

Thereafter, the training apparatus further trains the behavior recognition model based on the first skeleton sequence and its behavior label and on the second skeleton sequence and its behavior label S630.

Specifically, the training apparatus computes a first loss by comparing a behavior type determined by the behavior recognition model from the first skeleton sequence with the behavior label of the first skeleton sequence. The training apparatus computes a second loss by comparing a behavior type determined by the behavior recognition model from the second skeleton sequence with the behavior label of the second skeleton sequence. The training apparatus computes the overall loss as a weighted sum of the first and second losses, and updates the behavior recognition model so that the overall loss decreases.

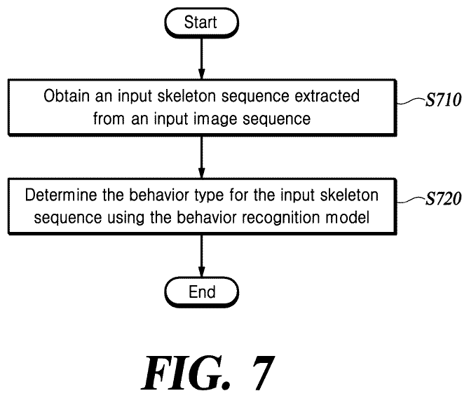

FIG. 7 is a flowchart of a behavior recognition method according to one embodiment of the present disclosure.

In what follows, the behavior recognition apparatus refers to the behavior recognizer 140 in FIG. 2.

Referring to FIG. 7, the behavior recognition apparatus obtains an input skeleton sequence extracted from an input image sequence S710.

Here, the input skeleton sequence is extracted by the skeleton extraction model, which is the model used to generate training data for the behavior recognition model.

The behavior recognition apparatus may determine the behavior type for the input skeleton sequence using the behavior recognition model S720.

Specifically, the behavior recognition model may output a probability distribution over behavior types for the input skeleton sequence, and the behavior recognition apparatus may determine the behavior type with the highest probability as the behavior type of the input skeleton sequence.

Here, the behavior recognition model is a model trained according to one of the training methods described in FIGS. 2 to 6.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method comprising:
preparing a first skeleton sequence extracted by a skeleton extraction model from a first training image sequence and a behavior label of the first skeleton sequence, wherein the first skeleton sequence includes first noise caused by the skeleton extraction model; and
training a behavior recognition model based on the first skeleton sequence and the behavior label of the first skeleton sequence.

2. The method of claim 1, further comprising:
preparing a second skeleton sequence generated by adding second noise to a reference skeleton sequence of a second training image sequence and a behavior label of the second skeleton sequence, wherein the second noise is generated based on statistics of joint movements for behavior types.

3. The method of claim 2, wherein training of the behavior recognition model includes training the behavior recognition model based on the second skeleton sequence and the behavior label of the second skeleton sequence.

4. An apparatus comprising:
a memory storing instructions; and
at least one processor,
wherein the at least one processor executing the instructions performs steps comprising:
preparing a first skeleton sequence extracted by a skeleton extraction model from a first training image sequence and a behavior label of the first skeleton sequence, wherein the first skeleton sequence includes first noise caused by the skeleton extraction model; and
training a behavior recognition model based on the first skeleton sequence and the behavior label of the first skeleton sequence.

5. The method of claim 4,
preparing a second skeleton sequence generated by adding second noise to a reference skeleton sequence of a second training image sequence and a behavior label of the second skeleton sequence, wherein the second noise is generated based on statistics of joint movements for behavior types.

6. The method of claim 5, wherein training of the behavior recognition model includes training the behavior recognition model based on the second skeleton sequence and the behavior label of the second skeleton sequence.

7. A method comprising:
obtaining an input skeleton sequence extracted from an input image sequence; and
determining a behavior type for the input skeleton sequence using a behavior recognition model,
wherein the behavior recognition model is trained by:
preparing a first skeleton sequence extracted by a skeleton extraction model from a first training image sequence and a behavior label of the first skeleton sequence, wherein the first skeleton sequence includes first noise caused by the skeleton extraction model; and
training the behavior recognition model based on the first skeleton sequence and the behavior label of the first skeleton sequence.

8. The method of claim 7, wherein the behavior recognition model is further trained by:
preparing a second skeleton sequence generated by adding second noise to a reference skeleton sequence of a second training image sequence and a behavior label of the second skeleton sequence, wherein the second noise is generated based on statistics of joint movements for behavior types; and
training the behavior recognition model based on the second skeleton sequence and a behavior label of the second skeleton sequence.

9. The method of claim 8, wherein the input skeleton sequence is extracted by the skeleton extraction model.

10. A non-transitory computer-readable recording medium storing instructions that, when executed by a processor, cause the processor to perform the method of claim 7.
